(19) United States
(12) Patent Application Publication
(10) Pub. No.: US 2019/0012414 A1
(43) Pub. Date: Jan. 10, 2019

(54) Modeling Sand Production

(71) Applicant: Rockfield Software Limited, Swansea (GB)

(72) Inventors: Adam Toby Bere, Swansea (GB); Jun Kato, Swansea (GB)

(21) Appl. No.: 15/651,759

(22) Filed: Jul. 17, 2017

(30) Foreign Application Priority Data
Jul. 4, 2017 (GB) 1710706.1

(51) Int. Cl. G06F 17/50

(52) U.S. Cl. CPC G06F 17/5018

(57) ABSTRACT

A computer implemented method of simulating sand production in a wellbore including providing a finite element mesh, using the finite element mesh to model a mechanical field, a porous flow field and a mass field at the wellbore, exchanging information two ways between each field in the model, and updating the simulation, such that there is a three way coupling between the mechanical field, porous flow field and mass field in the model.

### CROSS-REFERENCE TO RELATED APPLICATIONS

This application claims the benefit of UK Application No. 1710706. 1 filed 4 Jul. 2017, the entire contents and substance of which is hereby incorporated by reference.

### BACKGROUND OF THE INVENTION

### 1. Field of Invention

This invention relates to computer implemented methods for modeling the production of sand from a bore hole/well, perforation of other sandface.

### 2. Background and Related Art

The production of sand in bore holes/wells (such as oil wells) is an important issue in the hydrocarbon industry.

Conventional bore holes/wells drilled in soft rock formations, wherein ‘soft’ is typically defined as having a compressive strength of less than 1,000 psi, commonly produce sand or other fine particles along with the fluids being extracted. Sand production is unwanted because it can plug wells, erode equipment, and reduce well productivity. It also has no economic value. In certain regions most potential reservoirs (such as oil reservoirs) are located in soft rock formations and the cost of dealing with sand production in the wells results in considerable added expense to operations.

If the production velocity in the well is insufficient to transport the sand produced to the surface, it will begin to fill the inside of the well casing. Eventually, the producing interval may be completely covered with sand. In this case, the production rate will decline until the well becomes “sanded up” and production ceases. In-situations like this, remedial operations are required to clean out the well and restore productivity.

One cleanout technique is to run a “bailer” on a wireline to remove the sand from the production tubing or casing. Because the bailer removes only a small volume of sand at a time, multiple wireline runs are necessary to clean out the well. Another known cleanout operation involves running a smaller diameter tubing string or coiled tubing down into the production tubing to agitate the sand and lift it out of the well by circulating fluid. The inner string is progressively lowered while circulating the sand out of the well. This operation must be performed cautiously to avoid the possibility of sticking the inner string inside the production tubing. If the production of sand is continuous, the cleanout operations may be required periodically, as often as monthly or even weekly, resulting in lost production and increased well maintenance costs.

Alternatively, if the production velocity in the well is sufficient to transport the sand to the surface, the sand may still become trapped in the surface equipment (e.g. separator, heater treater) or in the production flowline. If enough sand becomes trapped in one of these areas, cleaning will be required to allow for efficient production of the well. To restore production, the well must be shut in, the surface equipment opened, and the sand manually removed. In addition to the cleanout cost, the deferred production incurs additional costs.

In addition, fluids which contain, or are transporting, sand are highly erosive. If the erosion is severe or occurs over a long enough period of time, complete failure of surface and/or downhole equipment may occur, resulting in critical safety and environmental problems as well incurring the costs of replacing or fixing equipment and delaying production.

Sand production can also result in the collapse of the formation around the well if large enough volumes of sand are produced. The collapse of the formation particularly becomes critical to well productivity if the formation material fills the perforation tunnels. Even a small amount of formation material filling the perforation tunnels will lead to a significant increase in pressure drop across the formation near the wellbore for a given flow rate.

In light of the above problems it is therefore desirable to control sand production downhole.

Methods for predicting the rate of sand production and the impact of sand production include field observations, laboratory experiments, and theoretical simulations or models. It is advantageous to accurately predict production rates of sand in wells so that appropriate control measures can be implemented to mitigate the effects of the sand, thereby reducing the need for expensive intervention and cleaning methods.

For field observations the engineer needs to know the conditions under which a well will produce sand. This is not always a straightforward task and so field observations are generally not very reliable. At its simplest, sand prediction involves observing the performance of nearby offset wells.

In exploratory wells, a sand flow test is often used to assess the formation stability. A sand flow test involves sand production being detected and measured on surface during a drill stem test (DST). Quantitative information may be acquired by gradually increasing flow rate until sand is produced, the anticipated flow capacity of the completion is reached or the maximum drawdown is achieved. Drawdown is defined as the variation between the bottom hole flowing pressure (BHFP) and the reservoir pressure.

A sonic log can be used as a way of assessing the sand production potential of wells. The sonic log records the time required for sound waves to travel through the formation. The porosity is related to the sound waves' travel time. Short travel times are indicative of low porosity and hard, dense rock; while long travel times are associated with softer, lower density, higher porosity rock. Softer rock is much more likely to result in increased sand production. A common technique used for determining if sand control is required in a given geologic area is to correlate incidences of sand production with the sonic log readings. This establishes a quick and basic approach to the need for sand control, but the technique can be unreliable and is not strictly applicable in geologic areas other than the one in which it was developed.

Thus, analytical methods are known for predicting sand production rates in wells, but these are generally of limited use geographically and often inaccurate due to the simplifying assumptions made.

Theoretical simulation or modeling of sand production in a well is also known. For example, finite element simulations have been used to model sand production. The effects of formation stress associated with fluid flow in the immediate region around the wellbore can be simultaneously computed with finite element analysis. Although these methods are very rigorous, they require very detailed and accurate knowledge of the processes involved in sand formation. Thus, known theoretical simulations are often laborious, computationally inefficient, and require the user to input large amounts of detailed specifications.

It is an object of the present invention to provide an improved computer implemented method for modeling sand production which addresses the above problems.

### BRIEF SUMMARY OF THE INVENTION

Briefly described, according to a first aspect of the invention, there is provided a computer implemented method of simulating sand production in a wellbore, the method comprising:
providing a finite element mesh; and
using the finite element mesh to model a mechanical field, a porous flow field and a mass field at the wellbore;
wherein the method comprises exchanging information two ways between each field in the model and then updating the simulation, such that there is full coupling between the mechanical field, porous flow field and mass field in the model.

‘Two ways’ means back and forth (i.e. in a first and a second direction) between each of the fields. In other words, in the model information can be exchanged:

i) from the mechanical field to the porous flow field; and

ii) from the porous flow field to the mechanical field; and

iii) from the mechanical field to the mass field; and

iv) from the mass field to the mechanical field; and

v) from the porous flow field to the mass field; and

vi) from the mass field to the porous flow field.

The sand production prediction method according to the present invention is a significant innovation and a step-change enhancement of traditionally used analytical and basic numerical methods.

This method supplements traditional methods by providing insight into the volumes and rates of sand production, and not just the on-set of sand production. Therefore, this reduces the need of the conservative approaches currently used, and allows great production potential from oil and gas reservoirs. Furthermore, the method can aid to mitigate the need of expensive and time-consuming intervention associated with significant produced sand volumes.

In addition, the full coupling between each field in the model provides a more accurate ‘real-life’ simulation of sand production in wellbores compared to known theoretic methods. In comparison, known theoretical simulations fail to provide sufficiently realistic models for sand production, thus costly intervention (e.g. modification of designed sand control measures). Therefore, the present invention results in a safer, more efficient extraction of hydrocarbons from reservoirs, which is cost and time effective. This is because the simulation can be used to better show what measures need to be taken to deal with the effect of, and minimise, sand production before the extraction process is started.

Optionally, the method comprises modeling the mobilization of the sand grains.

The mobilization of the sand grains may be modelled in the mass field using an Eulerian approach.

Optionally, the mass field may be modelled using an Eulerian formulation, whereby the finite element mesh is considered a background framework and the migration of mass, including sand grains, passes from element to element without requiring the mesh to deform.

By using an Eulerian mass field, mobilization of grains can be captured without deformation of a Lagrangian mesh, unlike known finite element simulations. This is advantageous as it improves computational efficiency.

Additional advantages of the Eulerian formulation mass field are:
Grains will only contribute to produced sand volume when they reach the wellbore or perforation surface. Conventional methods assume grains contribute to produced sand volume from anywhere in the model if local conditions are satisfied;
Erosion of Finite Elements (which can be commonly used) is not required, which results in a more stable system and removes complexity associated with maintaining boundary conditions;
Varying sized grains can be mobilized at different fluid velocities—this means smaller grains can be mobilized through pore space given the right conditions, whist larger grains may remain stationary. Conventional methods do not distinguish between grain size and mobilization.

Modeling the mass field may involve solving an advection-diffusion equation with an implicit solver.

In some embodiments, the method includes representing mobile sand grains in the mass field, wherein the sand gains are produced in the simulation.

The method may include monitoring the concentration of in-situ sand grains and the location of mobilized sand grains at each element of the finite element mesh during the simulation.

Optionally, the method may further comprise modifying the properties of at least one of the mechanical field, porous flow field and mass field in the model based on the concentration of in-situ sand grains and/or the location of mobilized sand grains.

The method may include updating the mechanical field in the model to account for the mechanical strength of the in-situ (i.e. un-mobilized) sand grains.

Optionally, modeling the mechanical field includes providing a formation matrix which represents elasticity and strength of the wellbore.

The mechanical field may be modelled using a Lagrangian formulation, whereby the finite element mesh is distorted with any mechanical deformation of the formation matrix.

The method may include solving the Lagrangian formulation with an explicit solver.

In some embodiments, the method may comprise updating the porous flow field in the model to account for changes in the stress and/or strain in the mechanical field affecting the permeability of the wellbore.

The porous flow field may be modelled using an Eulerian formulation, whereby the finite element mesh is considered a background framework and the flow passes from element to element without requiring the mesh to deform.

The simulation may use different formulae to model the flow of gas and liquids (such as oil) in the porous flow field.

Optionally, updating the simulation includes updating the mass field in the model to account for changes to fluid velocity in the porous field.

Optionally, the simulation includes updating the mechanical field in the model to account for changes in effective stresses caused by the pore pressure in the porous flow field.

Optionally, updating the simulation includes updating the porous flow field in the model to account for changes in permeability caused by changes to mass concentration in the mass field.

Optionally, updating the simulation includes updating one or more of the mechanical field, porous flow field and/or mass field in the model to account for mechanical damage and/or deformation of the wellbore.

The simulation may be updated following each change to the mechanical field, porous flow field or mass field in the model.

In some embodiments, the simulation is periodically updated to account for any changes to the fields.

The method may further comprise inputting one or more sanding control measures into the simulation and optimizing the control measure(s) to limit the effects of sand production in the wellbore.

Optionally, the method includes inputting a sand screen into the simulation and optimizing the design and/or location of the sand screen to minimise the effects of sand produced in the wellbore.

The method may further comprise the step of optimizing one or more of: the location of the wellbore; the dimensions of the wellbore; and/or one or more parameters of the extraction method so as to minimise sand production in the wellbore.

Optionally, the method may comprise constructing or modifying a wellbore in line with the optimized parameters of the computer-implemented simulation.

In a second aspect of the present invention, there is provided a computer implemented method of simulating sand production in a wellbore, the method comprising:
providing a finite element mesh; and
using the finite element mesh to model a mechanical field, a porous flow field and a mass field at the wellbore;
wherein the mass field is modelled using a Eulerian formulation, whereby the finite element mesh is considered a background framework and the migration of mass, including sand grains, passes from element to element without requiring the mesh to deform.

By using an Eulerian mass field, mobilization of grains can be captured without deformation of a Lagrangian mesh, unlike known finite element simulations. This is advantageous as it improves computational efficiency.

Additional advantages of the Eulerian formulation mass field are:
Grains will only contribute to produced sand volume when they reach the wellbore or perforation surface. Conventional methods assume grain contribute to produced sand volume from anywhere in the model if local conditions are satisfied;
Erosion of Finite Elements (which can be commonly used) is not required, which results in a more stable system and removes complexity associated with maintaining boundary conditions;
Varying sized grains can be mobilized at different fluid velocities—this means smaller grains can be mobilized through pore space given the right conditions, whist larger grain may remain stationary. Conventional methods do not distinguish between grain size and mobilization.

The second aspect of the invention may comprise any of the features, essential or optional, of the first aspect of the invention as detailed above.

In a third aspect of the invention, there is provided a method of optimizing the extraction of hydrocarbon deposits via hydraulic fracturing, the method comprising:
simulating sand production in a wellbore using the computer implemented method according to the first or second aspects of the invention;
optimizing one or more parameters of the simulation to minimise sand production; and
constructing or modifying a wellbore in line with the optimized parameters of the computer implemented simulation.

The method may comprise positioning a sand screens in the wellbore, wherein the design and/or location of the sand screen has been optimized in the simulation.

The method may include the further step of pumping hydraulic fluid into the wellbore as per the computer implemented simulation. For example, the simulation may specify the optimum pumping speed or pressure of the hydraulic fluid.

These and other objects, features and advantages of the present invention will become more apparent upon reading the following specification in conjunction with the accompanying drawing figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various features and advantages of the present invention may be more readily understood with reference to the following detailed description taken in conjunction with the accompanying drawings, wherein like reference numerals designate like structural elements, and in which:

FIG. 1 shows an illustration of the three way or full coupling between the mechanical field, the mass field and the porous flow field in the simulation of the present invention;

FIG. 2a is a representation of the simulated porosity change due to mechanical deformation of the wellbore;

FIG. 2b is a representation of the simulated resultant flux magnitude and vectors in the porous flow field due to the mechanical deformation of the wellbore;

FIG. 3a is a representation of simulated screen plugging due to mass migration of sand particles concentrating against the sand screen of a wellbore;

FIG. 3b shows a graph of the effect of screen plugging on the produced fluid volume;

FIG. 4a shows a plan view of a simulated wellbore and represents the mechanical, porous flow and mass field's contribution to the in-situ formation;

FIG. 4b shows the formation and pore fluid representation in each field;

FIG. 5 is an example critical velocity curve for grain mobilization in the mass field;

FIG. 6 shows alternative critical fluid velocity curves wherein i) shows grain mobilization will only occur due to material dilation (i.e. volumetric increase); ii) illustrates multiple grain sizes with varying critical fluid velocity curves;

FIG. 7 shows a typical two dimensional (2D) wellbore model with completion system, with the finite element mesh shown;

FIG. 8 shows an example of inclined three dimensional (3D) wellbore model with completion system, wherein the wellbore is inclined in the direction of a principal stress; the right hand figures show contours of deformation due to production of the field;

FIG. 9 is a graph of simulated pore collapse strength with varying water saturation with respect to porosity of the wellbore;

FIG. 10 shows experimental and numerical results using an embodiment of the method of the present invention for combined water weakening and creep of chalk formations;

FIG. 11 shows the model setup and results for a simulation of water injection onto sand, demonstrating the water weakening effect;

FIG. 12 illustrates (left) the size effect (i.e. the effect of the size of the wellbore or perforations) on their predicted and experimental strength and stability and (right) mesh size objectivity;

FIG. 13 is a flow chart representing part of the method of an embodiment of the present invention involving material characterization; and

FIG. 14 shows a method to provide drawdown limits based on the volume of sand produced.

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

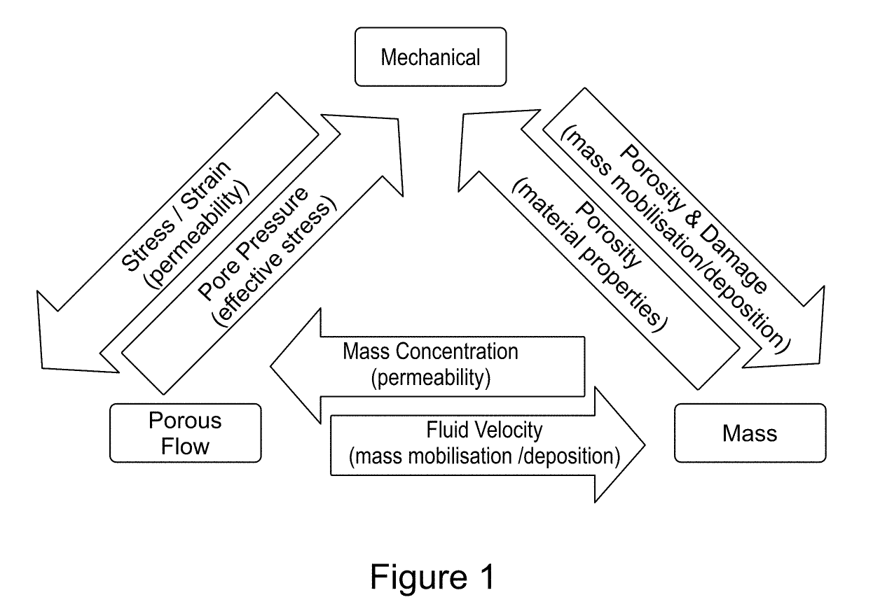

The coupling procedure used in the present invention incorporates three fields, namely Mechanical, Porous Flow and Mass. It is the strong coupling (information is passed 2-ways between each field) of these three fields that will enable efficient, accurate and detailed modeling required for sand production. The coupling between these three fields is shown in FIG. 1. The information passed both ways between each field is shown inside the arrows in FIG. 1. The simulations of each field are then updated to account for changes in the other two fields.

The coupling of the mechanical field considers the formation matrix in terms of elasticity and strength (mechanical properties). This allows weakening and strengthening of the mechanical properties under given conditions. Effective stresses are computed in the mechanical field, as well as the influences of local porous flow via permeability updates and mobilization of mass via damage criteria.

With regards to porous flow, this considers the flow of liquid or gas through a porous media governed by viscosity and porous media permeability. Time dependency is considered and pore pressures are computed in this field, as well as the influence of effective stresses in mechanical field via changes in pore pressures and mobilization of mass via flux.

The mass field considers the concentration evolution and movement of mass through a porous media. It may also consider fines migration or movement of granular particles; it influences permeability in the porous flow field via mass concentration and mechanical properties in mechanical field via porosity (mass concentration).

The mechanical field considers a Lagrangian formulation, whereby the finite element mesh distorts with the mechanical deformation of the formation matrix. This allows a degree of movement limited when the mesh is overly distorted and the simulations terminates—this may be overcome via re-meshing techniques if required.

The mechanical field is solved with an explicit solver. This allows softening of the material to be captured without convergence issues (typically implicit solvers suffer from failure to converge when the material softens). Due to the inherent softening of the rock formation when sand production occurs (disaggregation) this is an important aspect of the mechanical field.

The governing equation for the mechanical field is:

L^{T}(σ′(ϕ)−α(ϕ)mp_{f})+ρ_{b}g=0 (1)

### Where:

L is the standard continuum mechanics differential operator;

σ′ is the effective stress vector, which is computed reflecting porosity change captured in the mass field;

α is the Biot constant, which is a function of the porosity ϕ

m is a vector defined as m={1 1 1 0 0 0}^{T};

p_{f} is the fluid pressure (this is captured from the porous flow field);

ρ_{b} is the saturated bulk density; and

g is the gravitational vector.

The porous flow field considers an Eulerian formulation, whereby the finite element mesh is considered a background framework and the flow passes from element to element hence not requiring the mesh to deform. It is however important to specify a sufficiently detailed mesh discretization in areas of high gradient change of pore pressure. This is conducted with an implicit solver and hence allows for efficient modeling times.

It should be noted that although the fundamental formulation is the same, variations are required in the porous flow field to represent oil or gas reservoirs. Following are the key aspects of the formulation based on the application:

Gas Reservoirs will consider the following features/parameters: Gas compressibility, including ideal gasses—appropriate for low pressure and temperature and real gasses—compressibility covered over a range of pressures and temperatures; viscosity as a function of pressure; Darcy and non-Darcy flow models (Forchheimer and Barree-Conway) are available, non-Darcy flow models may be applied to capture high flow rate effects and gas slippage.

Oil Reservoirs will usually use Darcy flow models, which are suitable for most cases.

Changing between different formulations for gas/oil/water wellbores is possible within a single simulation, according to the present invention. The following governing equations are used, depending on the application (it should be noted that the intrinsic permeability may be a function of stress, strain or porosity).

Porous flow of gas:

$$div ( \frac{k ( {ɛ}_{mech} , {C}_{d} )}{{μ}_{g}} ( ∇ {p}_{g} - {ρ}_{g} g ) ) = ( φ \frac{\partial {ρ}_{g}}{\partial {P}_{g}} + ( 1 - φ ) \frac{\partial q}{\partial {P}_{g}} + ( {ρ}_{g} - q ) \frac{( α ( φ ) - φ )}{{K}_{s}} ) \frac{\partial {p}_{g}}{\partial t} + ( {ρ}_{g} - q ) α ( φ ) \frac{\partial {ɛ}_{v}}{\partial t} \qquad ( 2 )$$

### Where:

k is the intrinsic permeability, which is a function of the mechanical state change ε_{mech} and mass deposition C_{d}, captured from the mechanical and mass fields respectively;

μ_{g} is the gas viscosity, which is a function of pressure;

α is the Biot constant, which is a function of the porosity ϕ;

p_{g} is the gas pressure;

ρ_{g} is the gas density, which is a function of pressure and temperature;

q is the adsorbed gas mass;

Kₛ is the bulk modulus of the solid particles;

εᵥ is the volumetric strain captured in the mechanical field; and

g is the gravitational vector.

Porous flow of oil:

$$div ( \frac{k ( {ɛ}_{mech} , {C}_{d} )}{{μ}_{f}} ) ( ∇ {p}_{f} - {ρ}_{f} g ) = ( \frac{φ}{{K}_{f}} + \frac{( α ( φ ) - φ )}{{K}_{s}} ) \frac{\partial {p}_{f}}{\partial t} - α ( φ ) \frac{\partial {ɛ}_{v}}{\partial t} \qquad ( 3 )$$

### Where:

k is the intrinsic permeability, which is a function of the mechanical state change ε_{mech} and mass deposition C_{d}, captured from the mechanical and mass fields respectively;

μ_{f} is the fluid viscosity;

α is the Biot constant, which is a function of the porosity ϕ;

p_{f} is the fluid pressure;

ρ_{f} is the fluid density;

K_{f} is the bulk modulus of the fluid;

Kₛ is the bulk modulus of the solid particles;

εᵥ is the volumetric strain captured in the mechanical field; and

g is the gravitational vector.

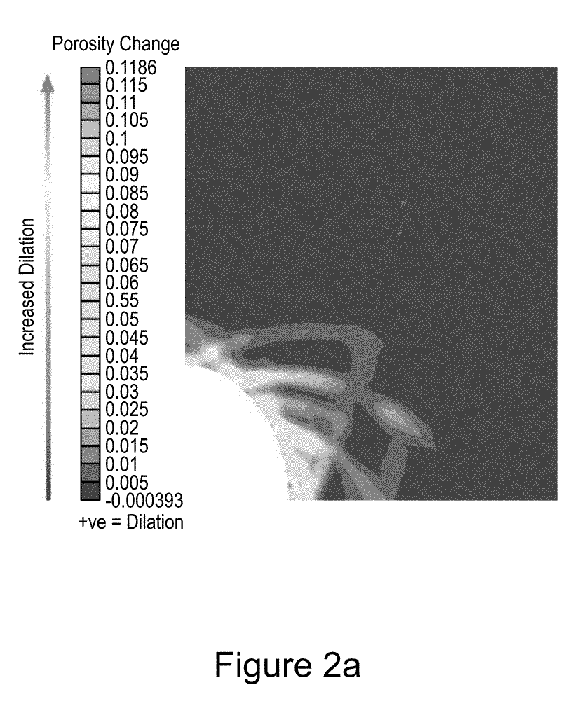

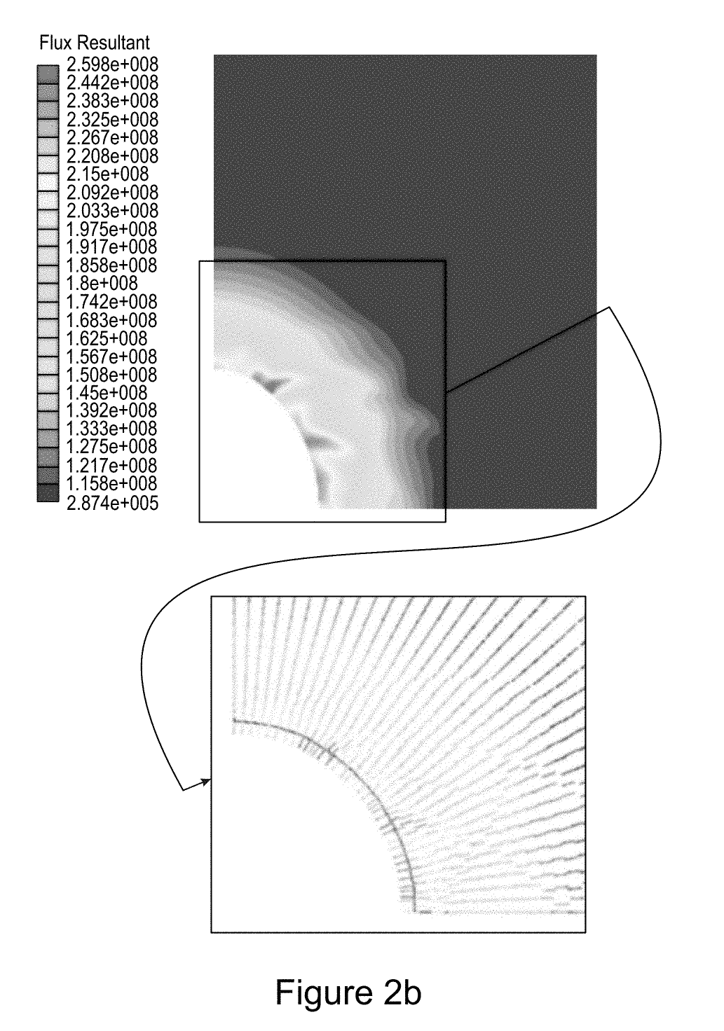

A relevant example of porous flow is displayed in FIG. 2 (this is actually a coupled mechanical-porous flow example which is necessary to display the porous flow functionality). This is a quarter-symmetry plan section of an open hole subject to excavation and subsequent drawdown/depletion.

The excavation of the wellbore has induced mechanical damage to the rock in the form of shear bands. The shear bands dilate the rock locally and hence, via coupling to the porous flow field, increase the permeability. As drawdown is simulated, the local permeability changes directly influence the resultant flux magnitude, and to a smaller degree, the flux orientation.

As for the porous flow field, the mass field considers an Eulerian formulation, whereby the finite element mesh is considered a background framework and the migration of mass (fines or grain particles) passes from element to element hence not requiring the mesh to deform. The mass field solves an advection-diffusion equation and is conducted with an implicit solver and hence allows for efficient modeling times. The implementation allows multi-particles to be represented with independent concentrations and deposition/mobilization criteria.

The generic governing equation for the mass field is as follows:

$$\frac{d}{dt} ( φ {C}_{i} + {C}_{di} ) + ∇ \cdot u {C}_{i} - ∇ \cdot ( {D}_{i} ∇ {C}_{i} ) = 0 \qquad ( 4 )$$

where:

Cᵢ is the mass concentration of the ith particle with unit mass/volume;

C_{di} is the deposited mass concentration of the ith particle, which is plugged into the formation, with unit mass/volume;

ϕ is the porosity of the formation medium;

u is the fluid flow velocity vector, where

$$u = - \frac{k}{μ} \frac{dp}{dx} ;$$

and

Dᵢ is the hydrodynamic dispersion coefficient of the ith particle, with unit area/time.

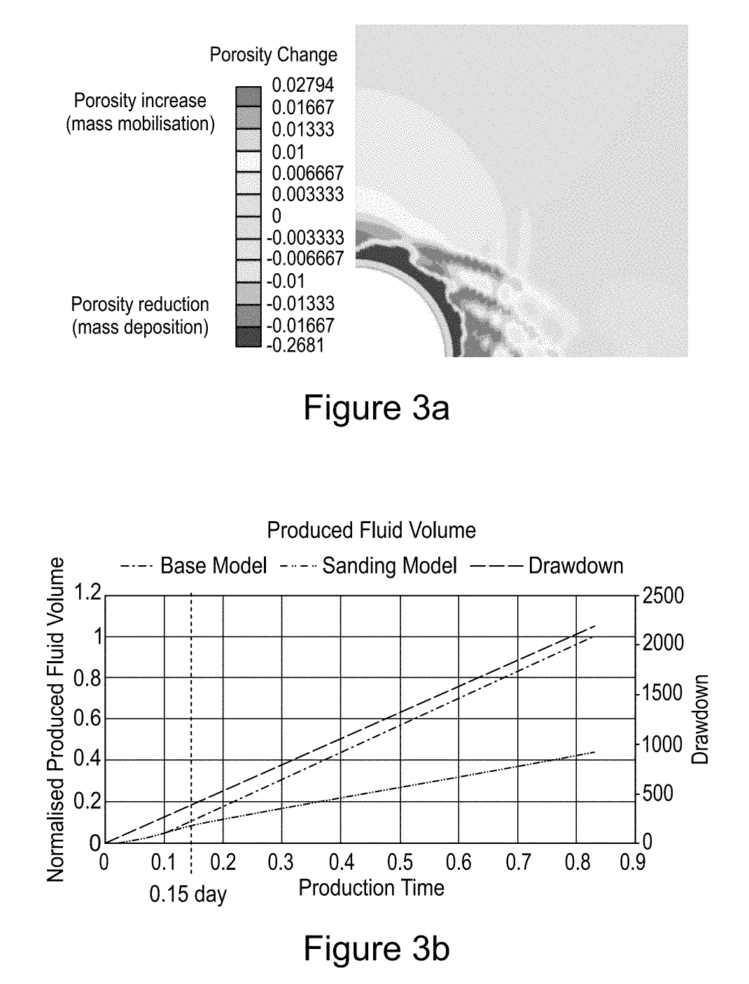

A relevant example of simulated mass migration is displayed in FIG. 3a (this is a three way or full coupled mechanical-porous flow-mass example which is necessary to display the mass concentration functionality). This is a quarter-symmetry plan section of an open hole subject to excavation, placement of a compliant sand screen and subsequent drawdown/depletion. Sand grains are not permitted to pass the screen.

FIG. 3b shows a graph of the produced fluid volume in the simulated open hole in FIG. 3a. Drawdown is shown to be a linear increase over time (the grey line which is plotted on the right Y-axis vs. production time at X-axis). The blue and orange lines are of produced fluid (Y-axis on the left), these show that when sanding is modelled the magnitude of produced fluid is less than the non-sanding base case.

The wellbore excavation induces shear band damage which disaggregates the formation and subsequent drawdown encourages localized high flux regions of fluid flow. The combination of the damage and flux is sufficient to mobilize the grains toward the screen and increase the mass concentration (porosity reduction). This porosity reduction reduces the permeability and hence in comparison to the base model (which has no mass movement) the production is reduced by over 50% for a given drawdown.

The second fundamental aspect of the proposed method involves the origin of the mobile grains, with respect to the field they are modelled in. It is proposed that:
the mechanical field contains only a ‘skeleton’ of the formation fabric (high porosity, for example 10% grain structure) from which sand cannot be produced from;
the mass field is initially prescribed a mass concentration (low porosity, for example 90% grain structure) which is combined with the mechanical ‘skeleton’ to represent the desired in-situ formation strength, grains in the mass field are able to be produced.

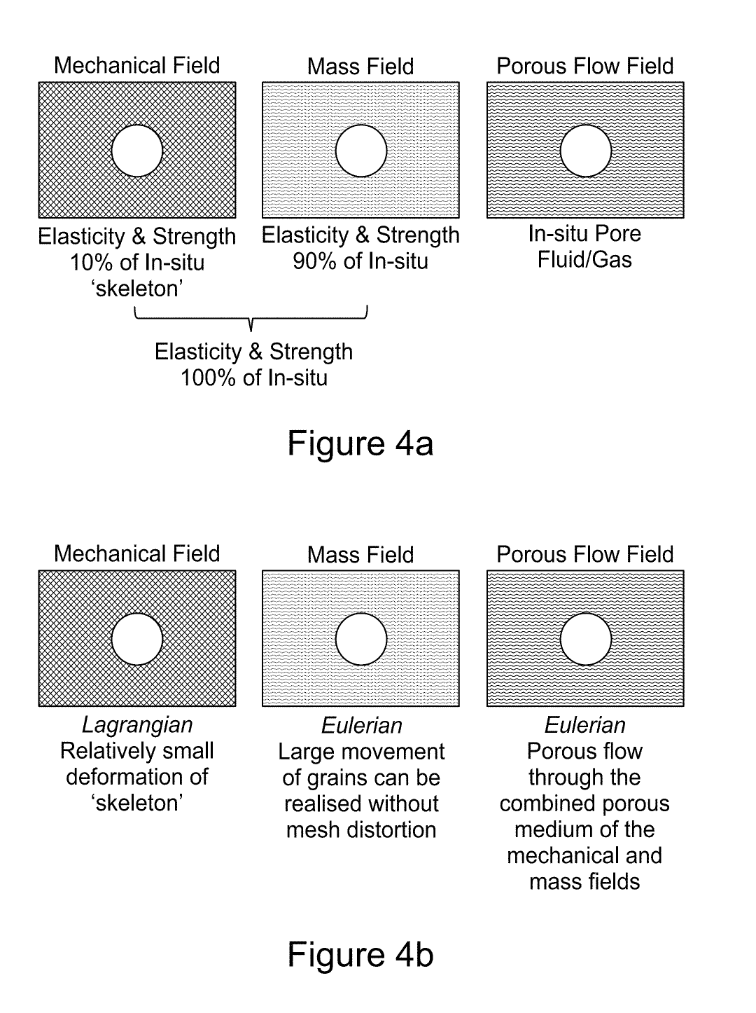

This methodology is presented in FIGS. 4a and 4b. FIG. 4a shows a plan view of a simulated wellbore and represents each of the mechanical, porous flow and mass field's contribution to the in-situ (immobilized) formation. The formation is the rock without the pore fluid, wherein pore fluid is the fluid that fills the small and often interconnected gaps in the rock. FIG. 4b presents the representation of the formation matrix and pore fluid in each of the three fields.

An advantage of the simulated mass field carrying grains which are capable of mobilization and production is that the mass field uses an Eulerian approach, so grain mobilization does not require deformation of the finite element mesh. As such, simulated grains can transpose large distances and significant volumes can be produced.

In contrast, a typical Lagrangian approach would be limited to small deformation and limited amount of sand production without instability, also grain mobilization through a porous medium cannot be represented. The present method therefore provides the advantage that grain mobilization can be predicted or modelled.

As grains in the mass field are mobilized, coupling with the mechanical field results in increased mechanical porosity and hence weakened material and stress modification. This enables large cavities to be formed which contain weak, potential disaggregated material.

The concentration of in-situ grains (i.e. grains which has not been mobilized and remain in their in-situ location) and mobilized grains will be monitored during the simulations at every location. This information is critical in characterizing the modified material properties of the formation following sand mobilization.

The mobilization of the in-situ grains represented in the mass field is dependent on a user-defined relationship between mechanical deformation/damage, stress, permeability, fluid viscosity and/or grain size and critical fluid (or gas) velocity; this also affects any subsequent deposition of grain if for example the fluid velocity reduces.

The relationship between stress and critical velocity is based on the assumptions that if grains (even completely disaggregated grains) are confined by stress they are more likely able to resist the drag force of the fluid velocity, and hence remain non-mobilized.

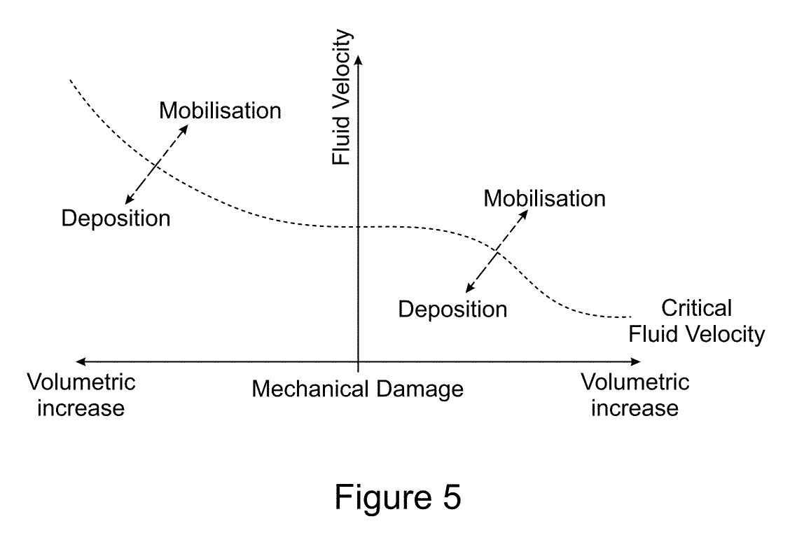

The example shown in FIG. 5 shows a variation of critical fluid velocity dependant on the mechanical damage imposed onto the formation. The mechanical deformation/damage can be induced by shear, compaction or tensile failure and may be measured by parameters such as porosity or effective plastic strain.

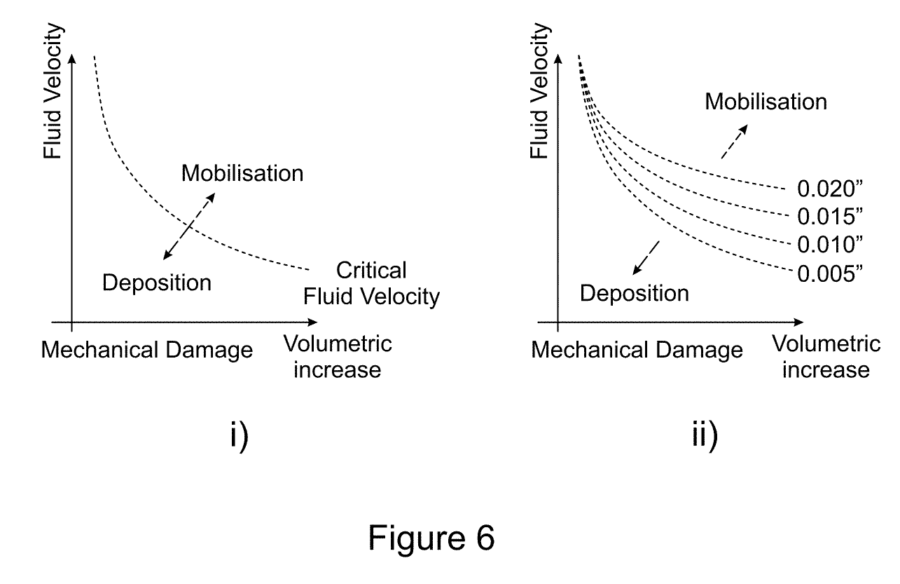

A key aspect of grain mobilization simulation is that multiple grain sizes may be assigned (grain size distribution), and that each size may be assigned a different critical fluid velocity curve as shown in FIG. 6. It is also important that grains cannot be mobilized as conglomerates. Only individual grains can be mobilized and produced as sand.

The relationship between grain size, mechanical deformation/damage, stress, fluid velocity and the mobilization of grains should come from assessment and back-analysis of lab/field data.

Various material properties are to be modified based on grain mobilization, either out from or into a domain. Table 1 details the influence of either mobile or in-situ grains on various material properties.

TABLE 1
Grain concentration influence on material properties

| | Material | | |
|---|---|---|---|
| Field | Property | In-situ Grains | Mobile Grains |
| Porous Flow | Permeability | Combined influence (i.e. porosity) | |
| | Bulk Fluid/Grain | No influence | Increased |
| | Viscosity | | concentration |
| | | | relates to |
| | | | increased |
| | | | viscosity |
| Mechanical- | Young's Modulus | Combined influence (i.e. porosity) | |
| Elastic | Poisson's Ratio | Combined influence (i.e. porosity) | |
| Mechanical- | Cohesion | Reduced | No influence |
| Shear Strength | | concentration relates | |
| | | to reduced cohesion | |
| | Friction Angle | Combined influence (i.e. porosity) | |
| Mechanical- | Tensile Strength | Reduced | No influence |
| Tensile Strength | Value | concentration relates | |
| | | to reduced tensile | |
| | | strength | |
| Mechanical- | Compressive Cap | Combined influence (i.e. porosity) | |
| Compressive | | | |
| Strength | | | |

The above conditions are on the assumption that: a significant amount of mobile grains will affect the bulk viscosity of the fluid/grain mix; a mobile grain loses all cohesive bonds; and tensile strength is a function of the strength of cohesive bonds.

Within a depleting field environment it is common that as more and more oil/gas is extracted the water table will raise and eventually reach the well, this is considered the water-cut. The influence of the water cut is: change of pore fluid viscosity; and loss of capillary action, which is realized in the mechanical strength as a reduction of cohesion and tensile strength.

The following sequence of steps is an example of the method of sand production prediction of the present invention.
Model initial set-up with 100% mechanical elasticity and strength (based on combined mechanical and mass fields)
Excavation of the wellbore is simulated, and potential mechanical damage is accrued
Drawdown/depletion is represented by reduction of pore pressure within wellbore and the model boundaries
The porous flow field calculates the pressure drop from the wellbore into the formation—this induces porous flow into the wellbore and directly affects the mechanical loading of the formation and may induce further damage
Mechanically damaged areas around the wellbore may affect the formation permeability and hence the direction and flux of the porous flow
Porous flow velocity and mechanical damage mobilize mass particles which may enter the well—sand production (in the mass field, these grains are extracted from the model at the wellbore surface)
Continued drawdown/depletion will, in a general sense, reduce the pore pressure and hence increase the effective stress loading—based on a constant total stress assumption
The increased effective stress loading will induce more damage to the mechanical field which will increase permeability and hence porous flow velocity
The combination of damage and increased porous flow velocity will lead to grain mobilization and potential sanding
A potential scenario which can be captured is the development of distinct shear bands around a wellbore drilled in anisotropic stress conditions, localized flow will be observed along the dilated shear bands (increased permeability)
The localized flow will inevitably have a higher velocity than the flow through the undamaged formation—this will encourage sand mobilization and production from the shear bands
The wedge of relatively undamaged sand (sandwiched by the shear bands) will not be mobilized or produce sand until damage and flow velocity reach the desired magnitude
Following initial grain migration and sand production, it is possible the system reaches a stable condition whereby grains are not mobilized
Stability may also be achieved due to a reduced fluid velocity or the formation supporting the wellbore has sufficient strength to remain in-place
With continued production it is possible the periods of stability are only temporary as the formation is likely to be further loaded and damaged
To represent the water cut (whereby water replaces oil/gas in the formation) the following key effects can be introduced into the simulation:
Removal of capillary action (which may be triggered at user defined saturation points)
Changed fluid viscosity from oil/gas to water
The water cut may be introduced instantaneously or gradually at any time in the simulation
The removal of capillary action can be introduced by reducing the cohesion and/or tensile strength of the material via a water-weakening mechanism
The change of fluid viscosity from oil/gas to water will promote more significant pore pressure gradients and hence more effective stress loading of the formation which may lead to further damage
Due to the water cut effect, this will encourage additional sand mobilization/production.

The method may allow for adaptive re-meshing. If distortion of the mechanical Lagrangian mesh becomes too extreme the simulation may be unstable and terminate. Adaptive re-meshing capabilities may therefore be employed to ensure simulation stability and continuation. However, the use of the mass field for grain mobilization should limit the deformation of the mechanical Lagrangian mesh, therefore even large cavities filled with disaggregated particles should be manageable without re-meshing.

The method of the present invention considers 2D and 3D models for both open-hole or cased and perforated configurations. It should be noted that other completions systems (such as gravel packs) may be considered in further application of this invention. Completion systems, or sand screen completion systems, may be installed within a well to provide stability and sand control during production.

The geometries for the simulation are provided in a parametric form such that the key geometric features can be modified by the user. This will significantly reduce the user effort in building and customizing the geometry. Following are further details of the modeling assumptions and key geometric parameters for 2D and 3D models.

2D simulations may be conducted with the following assumptions:
Plane strain conditions will be considered
For open hole or perforation geometries the axis must be aligned parallel and perpendicular to the principal stresses
Anisotropic stress conditions may be considered
For perforations the effect of wellbore excavation (relaxation of stresses and potential damage) cannot be represented; also only a single perforation may be modelled at a time.

Key geometric parameters for open-hole and cased and perforated 2D models:
Wellbore/perforation diameter (assumed circular)
Model boundary size (a default size will be applied based on a factor of the wellbore/perforation diameter)

3D simulations may be conducted with the following assumptions:
Worm-holes are considered to be a potential sanding failure mode
Various trajectories of wellbore with respect the initial principal stresses can be captured
Casing, cement and perforations may be represented in same model:
Multiple perforations may be modelled—this may be an important factor as linking of damage from adjacent perforations may provide increased sand production
The level of detail for 3D models will need to be offset with acceptable run times

Key geometric parameters for open-hole and cased and perforated 3D models:
Wellbore/perforation diameter (assumed circular)
Casing size (assumed central)
Perforations: number of, length, offset and angle between perforations
Wellbore inclination and azimuth (from vertical and North, respectively)
Stress components (direct and shear stresses) or principal stress components and inclination/azimuth
Model boundary size (a default size will be applied based on a factor of the wellbore inclination/diameter or perforation length

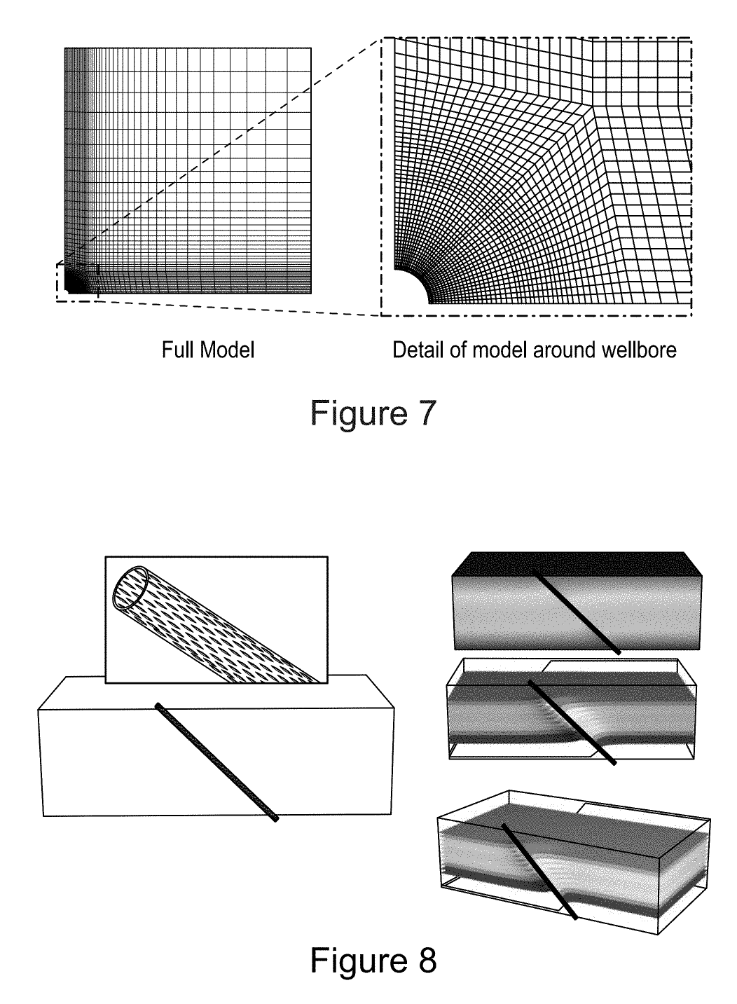

An example of a 2D model is shown in FIG. 7 and an example of a 3D model is shown in FIG. 8. The right hand figures in FIG. 8 show contours of deformation due to production of the field, wherein the relative stiffness contrast of the completion system and rock causes the variation of pattern.

In order to model sand production of sandstone reservoirs, the following features may be considered in the method of the present invention:

Non-linear elasticity—both Young's modulus and Poisson's ratio can be defined as dependant on pressure and/or porosity—this can allow for stiffening of a compacting material or softening of the dilating material;

Critical-state theory—shear (dilation) and compaction failure modes can be represented with associated volumetric change;

Pore collapse representation—prior to cataclastic failure of a formation material, matrix yield or pore collapse is a non-linear irreversible failure mode common in high porosity formations subjected to large depletions; and

Water-weakening—for sand production prediction where water cut is a possibility, the strength of the formation may be modified by the introduction of water saturation—the modification may be applied to many features of the material model (further information later).

The method should also be adaptable to capture specific material behaviors in a particular area, as these may differ from standard models.

The appropriate constitutive material model to represent compacting reservoirs with local shear or tensile failure is the ‘Soft Rock 3’ or ‘SR3’ model. This is an extension of the modified Cam-Clay constitutive model, and is based on critical state theory whereby volumetric strains reflect strength changes.

The key parameters associated with the SR3 material model are as follows:

Yield Surface Definition, this includes:
Shear strength—similar to cohesion and friction angle for Mohr Coulomb—commonly known as the dry or brittle side;

Compression ‘end’ cap—commonly known as the wet or ductile side; and

Tensile cut-off limit—Rankine surface is defined, dilation of material that fails in tension.
Critical State Line, this includes definition of the transition between shear dilation and compressive compaction—this is a smooth transition in the SR3 model; can be defined as associative or non-associative.
Hardening/softening Law: Rate of plastic volumetric deformation associated with stress changes following material yielding.

It should be noted that the yield surface may be prescribed a near linear shear surface and extended compression ‘cap’ and hence would represent closely a Mohr Coulomb failure plane.

The following describes the water-weakening feature. This is considered an appropriate method to represent the water cut effects on the strength of sandstones, which may induce accelerated sand production. Water-weakening has been used extensively for North Sea chalk in Enhanced Oil Recovery (EOR) fields with water injection, as will be described below.

Currently the following material parameters can be weakened via the water saturation proxy, which may be user specified with respect to time: Young's Modulus; Poisson's ratio; critical state gradient; frictional parameter; pre-consolidation pressure (p_{c}); tensile strength and fracture energy.

Weakening of all the material parameters can be specified by user defined curve of scaling factor against water saturation. The weakening factor assignment for each parameter is independent of each other (e.g. different curve can be assigned for friction parameter and tensile strength).

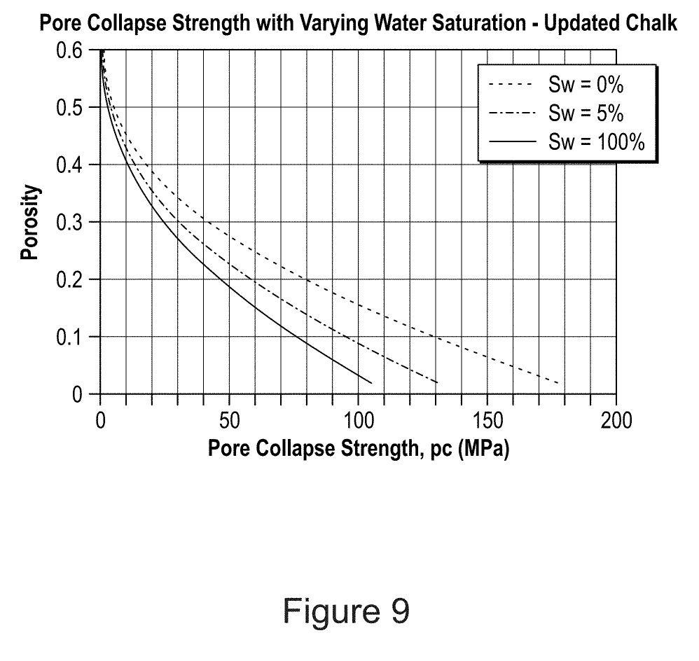

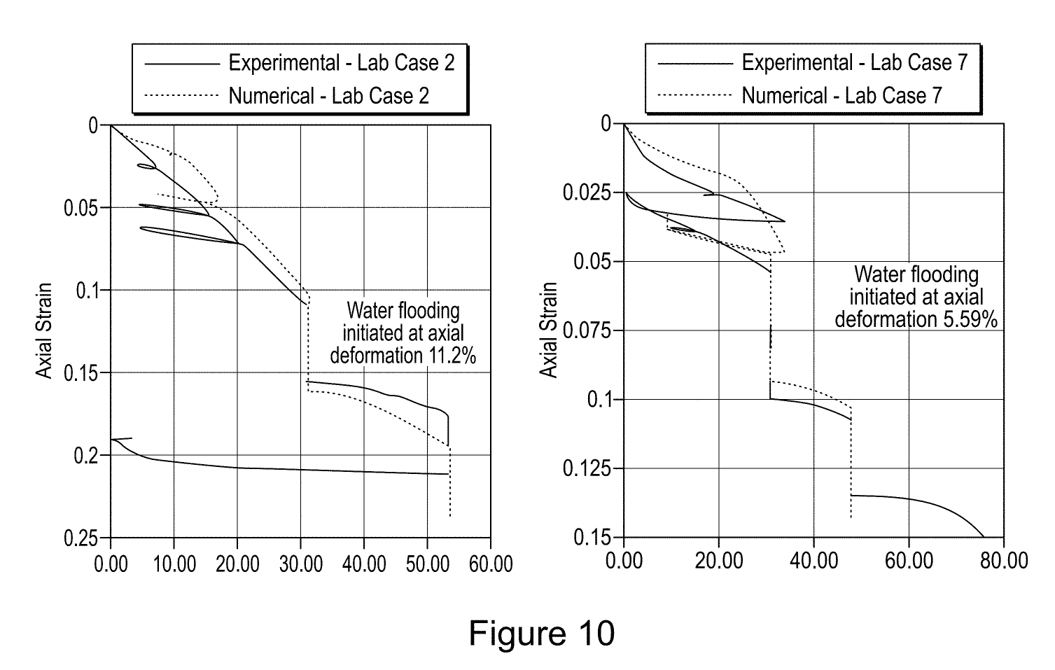

FIG. 9 shows a typical user defined influence of water saturation on pre-consolidation pressure (p_{c}). Furthermore, FIG. 10 displays experimental lab test results and the corresponding numerical back analysis results for combined creep and water-weakening assessment. A good correlation can clearly be seen for both these effects.

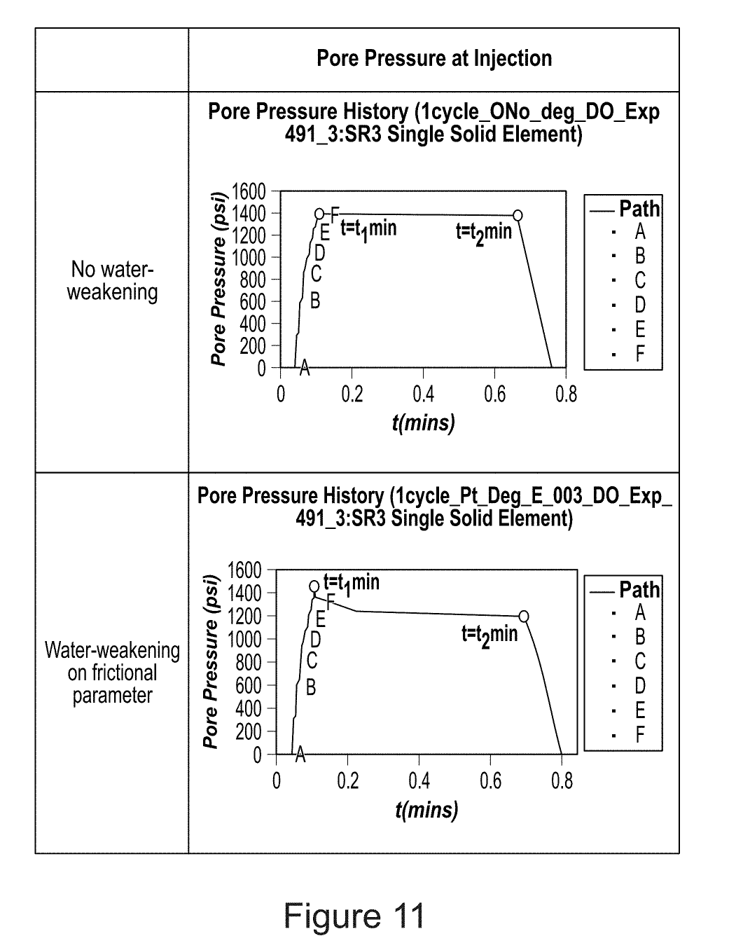

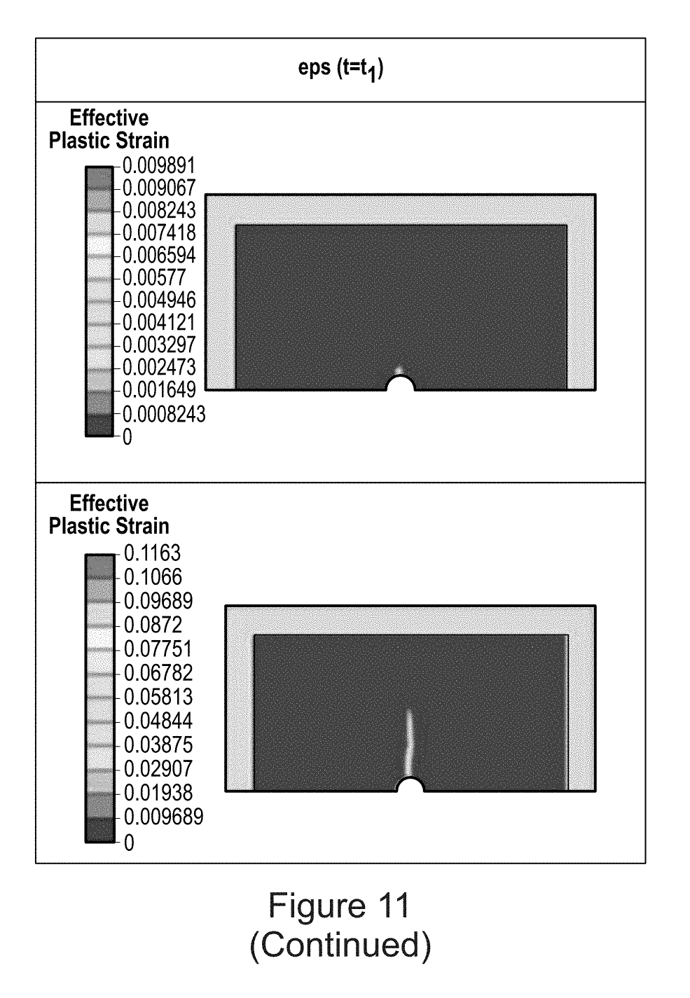

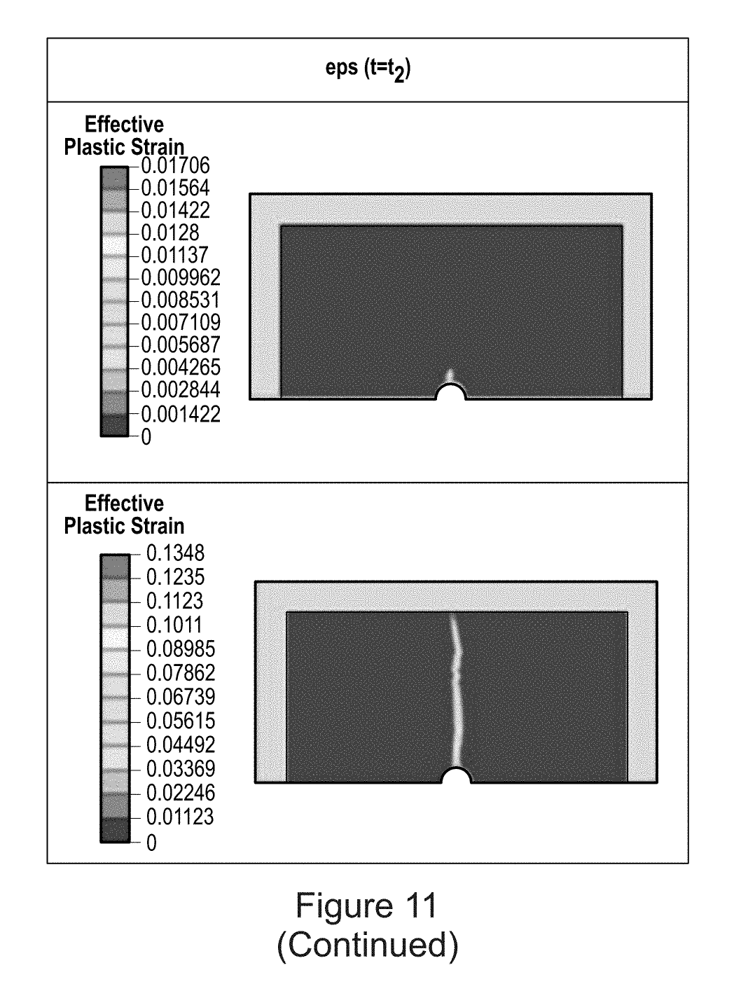

FIG. 11 shows the model set-up and results for a simulation of water injection onto sand, which incorporates the water-weakening effect. The water-weakening was a proxy for a potential chemical influence affecting the frictional parameters of the SR3 model. The results show with and without water-weakening and compare the pore pressure evolution at the injection point and damage propagation. The material with water-weakening shows a lower peak pressure and clear damage propagation in perpendicular to the minimum stress.

This demonstrates the capability and also the stability of the simulation to capture mechanical ‘damage’ via the water-weakening effect.

Scale effects are recognized to influence the onset of sand production in sand prediction methodology. The smaller the cylindrical cavity in a porous formation the larger the apparent strength of hollow cylinder, at yield and total collapse; this reflects that linear elasticity is a simplification, and that rocks in a practical sense have complex behavior, even up to yield.

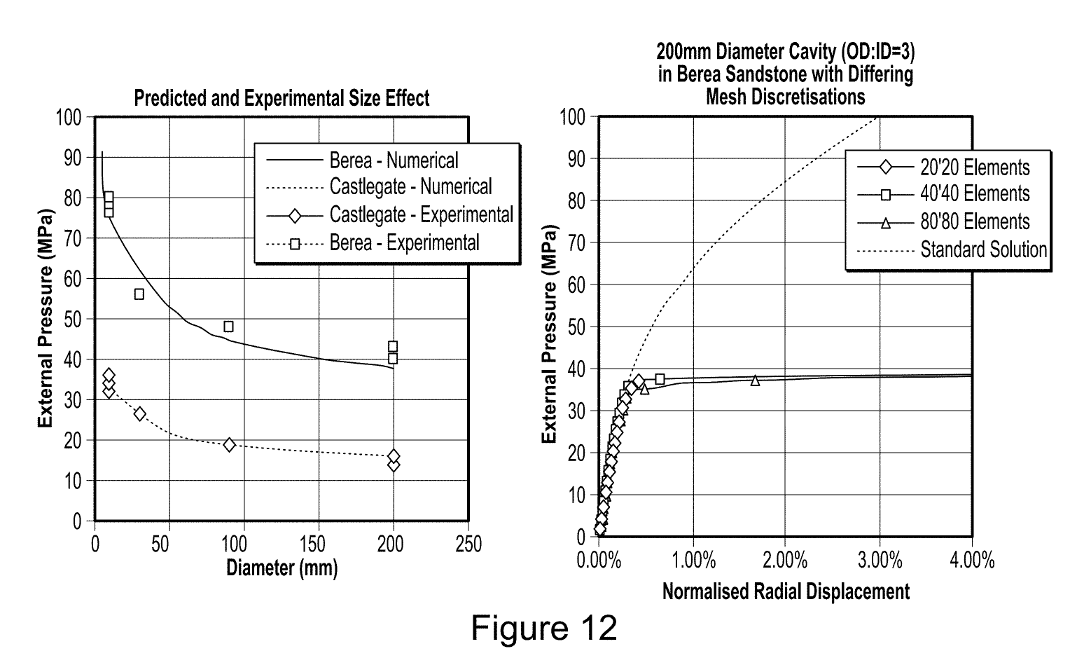

The method of the present invention includes a regularization parameter to capture the predicted size effect. This is in good agreement with the experimental data for both the Berea and Castlegate sandstones, which are both common and well known types of sandstone. This is also invariant for differing mesh discretizations, see FIG. 12 which shows the size effect of the wellbore or perforations on predicted and experimental strength and the regularization impact on differing mesh discretizations.

The characterization of sub-surface materials is generally based on a combination of back analysis of lab scale testing (where available) and correlation to well log information, otherwise it solely uses log based data.

Lab tests involve the determination of shear, tensile and compressive failure modes and the subsequent plasticity/residual strength. Also considered are the flow characteristics, such as permeability. Tests that are more sophisticated may involve thick walled cylinder tests with determination of sand production initiation.

Well logs may be used to derive a range of parameters such as elasticity, density/porosity, unconfined compressive strength (UCS) values, friction angle, etc. By using both lab scale tests and correlating to the equivalent location/porosity from a well log, the material variation along a well trajectory may be established.

The characterization of the method of the present invention can utilize all information provided via the well log assessment. However, due to the sophistication of the model (required to capture the sand production at the level requested) additional definitions will be required. Through the calibration of the technology, particularly the comparison to lab and field observation, these additional definitions will be refined such that upper and lower bounds are established. Furthermore, where possible, a correlation between available log data and/or lab test results and these definitions will be defined to provide a best estimate.

For each material component, it is important to consider the influence on sand production across the likely range of that parameter—the likely range will be attributed to the data source (e.g. log data or lab data). For example (note this is not an expectation):
elastic properties have a low influence on sand production across the likely range due to:

1. the range of elastic properties for a given location along the well is well defined

2. elasticity is not a key driver for sand production
plastic softening will have a high influence on sand production across the likely range due to:

1. a wide range of permissible values;

2. plastic softening is a key driver for sand production.

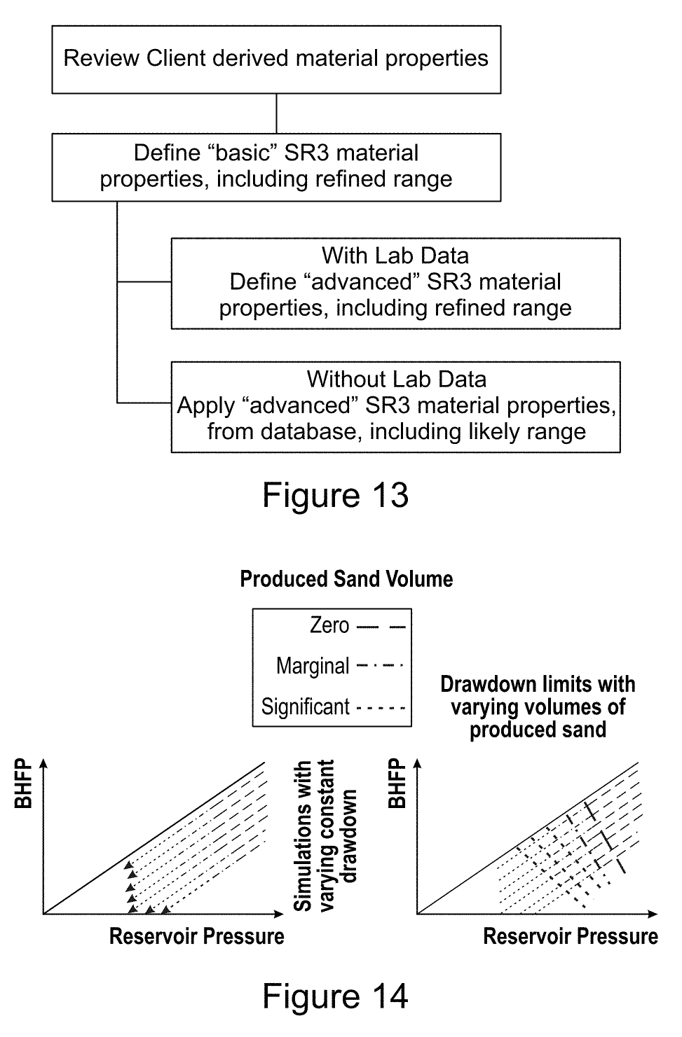

Therefore, capturing the likely range of each parameter will guide the parameter space, which needs to be considered for sensitivity studies. As mentioned above, the likely range of each parameter will be dependent on the outcome of the studies and the data acquisition of the well. The characterization of materials will follow a path similar to the flow chart in FIG. 13.

The following are the loading and constraints which can be applied to the 2D and 3D models of the present invention:

Wellbore & Perforations
Initialization (application of initial stresses, pore pressures and material state)
   Full constrained wellbore surface
   Perforations are initially filled with formation material
Excavation
   The wellbore constraint is gradually relaxed and a pressure load commensurate with the mud-weight is applied
   Perforations materials are removed and mud-weight is applied
Drawdown/Depletion
   Mud-weight loading is removed and pore pressure of the wellbore/perforations is reduced with respect to the BHFP defined by the user
   Alternative to BHFP, the production flux of gas may be defined on the wellbore/perforation surface

Model Boundary
Initialization/Excavation
   Boundary is fully fixed and pore pressure is maintained at the initial reservoir pressure
Drawdown/Depletion
   The pore pressure response on the model boundary will follow a one dimensional (1D) trend based on the wellbore pressure and intact formation permeability—this may be adjusted as required
Upper surface prescribed a constant total stress pressure loading and may be subject to subsidence
   If depletion of the reservoir is sufficient to induce compact of the formation, this may be realized
   Note, the side boundaries of the model will be constrained with planar rollers such that compaction of the reservoir can be realized

Formation Domain
Initialization
   Initial stresses and reservoir pore pressure are applied—following initialization the pressure are allowed to develop as defined in the porous flow field
Water Cut
   The water saturation of the formation domain is controlled by a user defined saturation-time curve

The simulated duration of the model (days/months/years) will be dependent on the loading conditions and formation response. It is anticipated that sand production will be initiated at specific times, for example at the beginning of drawdown as the flow velocity is increased to a peak magnitude, and when water cut is reached. Therefore, at these times, the simulations time-steps in all fields will need to be sufficiently small to capture the desired effects.

For the porous flow and mass fields the time step is automatically controlled with convergence controls. For the mechanical field the time step is controlled by a combination of element size and material stiffness. The mechanical time step can however be increased by the user. This user modification needs careful consideration but may reduce the analysis run-time and allow larger durations to be simulated.

It should be noted that the user modification of the mechanical time step may be changed during the simulation, for example a large time-step may be chosen up to water-cut, following which a smaller time-step may be employed to capture the anticipated damage with increased accuracy.

The following output may be provided from the sand production prediction models: overall cumulative sand production; overall rate of sand production Vs time; and/or distributions of pore pressure and stress along a selected cross-section; contour map of stress and pore pressure; spatial distribution of sanding zones; and/or disaggregation zone for a given degree of disaggregation, etc.

A consistent set of results will be output from the simulations to allow simple comparison due to varying parameters between simulations. These will include sand production volumes and rates with respect to time and drawdown, but also results such as the material state evolution, maximum porous flow flux and formation deformation at fixed locations will be provided to give a full understanding of the process and the potential for prediction of further sanding.

FIG. 14 demonstrates an output from a series of simulations that provides practical value in terms of drawdown limits based on sand production. In FIG. 14, the Y-axis is the bottom hole flow pressure (BHFP) and the X-axis is the reservoir pressure, so the drawdown is the difference between the reservoir pressure and the BHFP. This method provides a significant benefit as it defines less conservative drawdown limits in comparison to limits defined by sand production initiation.
Drawdown Vs Produced Sand Volume
   1. Run a series of batch simulations with varying but constant drawdown magnitude (all other parameters to remain consistent)
   2. Record the produced sand volume through analysis—see left graph in FIG. 14
   3. Generate plot of consistent produced sand volume on typical BHFP Vs Reservoir Pressure plot, as shown in right graph in FIG. 14. This forms the drawdown limits based on acceptable levels of sand production.

The following workflow is an example of the method of the present invention:

### 1. Initial Model Set-Up

Import of Log Data
   Initial screening assessment to determine the specific intervals for sand production prediction
   Select interval of interest
Application of Initial Conditions (principally from log data at interval of interest):
   Stresses/Pore Pressure
   Initial Water Saturation
   Initial Material Model and State
   Geometry (to be chosen from parameterized templates):
   Open Hole or Cased and Perforated (with user defined wellbore/case/perforation configurations)
   Well trajectory with respect to in-situ stresses

### 2. Simulation Loading Definition

User to define simulation loading parameters
   Excavation—mud-weight, filter cake efficiency
   Depletion Loading—Either BHFP Vs Time, or Total Produced Oil/Gas Volume Vs Time
   Water-cut—Water saturation Vs Time

### 3. Batch Simulation Runs

The user can defined the modeling parameter/s to be assessed, including material parameters
Assign the variation of the parameter/s and number of intervals to be assessed
Automatic generation of data-files & automatic sequential running of simulations

### 4. Post Simulations Assessment

Simulation assessment/performance
Results extraction/assessment
   Automatic comparison of key modeling output for the parameter variations assessed

Platform requirements should also be considered. In the present invention pre- and post-processing may both be conducted with Windows® platform. Simulations can be conducted either with Windows® (limited to sequential simulations) or Linux® (sequential or parallel processing).

To ensure a reasonable turn-around of simulations to guide engineering strategy, the simulation run-time needs to be suitably scaled. It may be preferable to keep run-time to hours rather than days.

Run-times are inherently be linked to the level of detail applied to the model, for example 2D simulations will be faster than 3D. Therefore, it is proposed to consider different levels of detail for both 2D and 3D models. Initial ‘screening’ simulations can be conducted with less detail but higher run-time efficiency. Following the screening a reduced number of high detail simulations may be conducted. These require longer run-times but less simulations will be required due to the initial screenings.

In order to provide efficient parameter sensitivity assessments, batch simulations may be conducted. These will consider automatic generation of a series of data-files with varying parameter space (for example ±10% Young's modulus). Additionally, the simulations may be automatically run, and with consistent result sets a comparison of the parameter sensitivity can be conveniently assessed.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A computer implemented method of simulating sand production in a wellbore, the method comprising:
providing a finite element mesh;
using the finite element mesh to model a mechanical field, a porous flow field and a mass field at the wellbore;
exchanging information two ways between each field in the model; and
updating the simulation;
such that there is a three way coupling between the mechanical field, porous flow field and mass field in the model.

2. The method of claim 1 further comprising modeling the mobilization of sand grains.

3. The method of claim 1, wherein modeling the mass field comprises solving an advection-diffusion equation with an implicit solver.

4. The method of claim 1, wherein modeling the mechanical field comprises providing a formation matrix that represents elasticity and strength of the wellbore.

5. The method of claim 1 further comprising modeling the porous flow field using an Eulerian formulation including:
considering the finite element mesh a background framework; and
passing the flow from element to element without requiring the finite element mesh to deform.

6. The method of claim 1, wherein updating the simulation comprises one or more of:
updating the mass field in the model to account for changes to fluid velocity in the porous field;
updating the mechanical field in the model to account for changes in effective stresses caused by the pore pressure in the porous flow field;
updating the porous flow field in the model to account for changes in permeability caused by changes to mass concentration in the mass field;
updating the porous flow field in the model to account for changes in the stress and/or strain in the mechanical field affecting the permeability of the wellbore;
updating one or more of the mechanical field, porous flow field and mass field in the model to account for mechanical damage and/or deformation of the wellbore;
updating the simulation following each change to the mechanical field, porous flow field or mass field in the model; and
updating the simulation periodically to account for any changes to the fields.

7. The method of claim 1 further comprising one or more of:
inputting a sanding control measure into the simulation and optimizing the control measure to limit the effects of sand production in the wellbore;
inputting a sand screen into the simulation and optimizing the design and/or location of the sand screen to minimize the effects of sand produced in the wellbore;
optimizing the location of the wellbore;
optimizing the dimensions of the wellbore; and
optimizing one or more parameters of the method so as to minimize sand production in the wellbore.

8. The method of claim 2, wherein modeling the mobilization of the sand grains comprises modeling the mobilization of the sand grains in the mass field using an Eulerian formulation including:
considering the finite element mesh a background framework; and
passing the migration of mass, including sand grains, from element to element without requiring the finite element mesh to deform.

9. The method of claim 4, wherein modeling the mechanical field comprises:
modeling the mechanical field using a Lagrangian formulation; and
distorting the finite element mesh with any mechanical deformation of the formation matrix.

10. The method of claim 8, wherein varying sized sand grains can be mobilized at different fluid velocities in the mass field.

11. The method of claim 8 further comprising:
monitoring the concentration of in-situ sand grains; and
monitoring the location of mobilized sand grains;
wherein each of the steps of monitoring occurs at each element of the finite element mesh during the simulation.

12. The method of claim 9 further comprising solving the Lagrangian formulation with an explicit solver.

13. The method of claim 11 further comprising modifying the properties of at least one of the mechanical field, porous flow field and mass field in the model based on one or both of the concentration of in-situ sand grains and the location of mobilized sand grains.

14. The method of claim 13 further comprising updating the mechanical field in the model to account for the mechanical strength of the in-situ sand grains.

15. A computer implemented method of simulating sand production in a wellbore, the method comprising:
providing a finite element mesh; and
using the finite element mesh to model a mechanical field, a porous flow field and a mass field at the wellbore;
wherein the mass field is modeled using a Eulerian formulation, whereby the finite element mesh is considered a background framework and the migration of mass, including sand grains, passes from element to element without requiring the mesh to deform.

16. A method of optimizing the extraction of hydrocarbon deposits via hydraulic fracturing, the method comprising:
simulating sand production in a wellbore using the computer implemented method according to claim 1; and
modifying a wellbore in line with the optimized parameters of the computer implemented simulation.

17. The method of claim 16 further comprising optimizing one or more parameters of the simulation to minimize sand production.

18. The method of claim 16 further comprising:
inputting a sand screen into the simulation and optimizing the design and/or location of the sand screen to minimize the effects of sand produced in the wellbore; and
positioning the sand screen in the wellbore.

19. The method of claim 16 further comprising pumping hydraulic fluid into the wellbore as per the computer implemented simulation.

20. The method of claim 16, wherein modifying a wellbore in line with the optimized parameters of the computer implemented simulation comprises constructing a wellbore in line with the optimized parameters of the computer implemented simulation.

21. A method of optimizing the extraction of hydrocarbon deposits via hydraulic fracturing, the method comprising:
simulating sand production in a wellbore using the computer implemented method according to claim 15; and
modifying a wellbore in line with the optimized parameters of the computer implemented simulation.

22. The method of claim 21, wherein modifying a wellbore in line with the optimized parameters of the computer implemented simulation comprises constructing a wellbore in line with the optimized parameters of the computer implemented simulation.
